(19) United States
(12) Patent Application Publication
(10) Pub. No.: US 2026/0248111 A1
(43) Pub. Date: Aug. 27, 2026

(54) Method for Inducing Artificial hibernation of Fish and Method of Transporting Artificially Hibernated Fish

(71) Applicant: THE FISH CO., LTD., Pyeongtaek-si (KR)

(72) Inventor: Mun Seon GONG, Pyeongtaek-si (KR)

(21) Appl. No.: 18/715,698

(22) PCT Filed: Feb. 13, 2024
(86) PCT No.: PCT/KR2024/001974

§ 371 Date: Apr. 28, 2026

(30) Foreign Application Priority Data
Mar. 22, 2023 (KR) 10-2023-0037514

(51) Int. Cl. A01K 61/10; A01K 63/02; A01K 63/06

(52) U.S. Cl. CPC A01K 61/10; A01K 63/02; A01K 63/065

(57) ABSTRACT

The present invention relates to a method for inducing artificial hibernation of fish and a method of transporting artificially hibernated fish, and has an advantageous effect of increasing the adaptability of the fish to the decreasing water temperature and maintaining the inherent biological rhythm of the fish as much as possible, thereby extending the time of artificial hibernation as long as possible, by further including an adaptation step and a stabilization step, where the temperature is maintained at a predetermined temperature in the process of reducing the temperature, while water temperature from the initial water temperature is gradually reduced to the hibernation (lowest) water temperature at which the fish ceases to swim, unlike the convention method of continuous and repeated reduction in temperature from the initial water temperature.

### TECHNICAL FIELD

The teachings in accordance with exemplary and non-limiting embodiments of this invention relate generally to a method of artificially inducing hibernation in fish, and more particularly to a method of artificially inducing hibernation in fish that enables the fish to be packaged and transported in an artificially induced state for at least 36 hours in an anhydrous environment, and to a method of transporting the artificially hibernated fish.

### BACKGROUND OF THE INVENTION

Long-distance transport of live fish can be done by air, and there are two main ways of transporting live fish by air: in plastic bags with water and live fish in Styrofoam boxes, and in anhydrous form.

However, when transporting live fish in plastic bags, the weight and volume of the water makes the logistics costly.

In the case of transporting artificially hibernated fish in anhydrous form, the live fish are placed in a plastic bag, oxygenated, sealed, and transported.

This method reduces logistical costs by eliminating the need to transport water, but as the aircraft's altitude increases, the air pressure decreases, causing the plastic bag to burst, and the burst plastic bag sticks to the fish's body surface. When exposed to air, live fish breathe through their skin, and the plastic bag interferes with this process, causing them to die from lack of oxygen.

On the other hand, Registered Patent No. 10-1863586 filed by the Applicant discloses a technique for artificially hibernating fish and transporting them in anhydrous condition, but at the end of the artificial hibernation process, the water temperature is sharply lowered to the point where the fish stop swimming, causing cold shock to the fish. A 3 to 4° C. change in water temperature in a short period of time at low temperatures is stressful to fish, no matter how acclimatized they are, and this stress can reduce quality and survival.

In addition, Registered Patent No. 10-1994151 filed by the Applicant and the inventor discloses a technology for artificially hibernating fish by gradually reducing the water temperature from an initial water temperature of 15-17° C. to a hibernation minimum temperature of 3-5° C. However, this technology has the disadvantage that the time for inducing fish to hibernate in an anhydrous state is relatively short (30 hours) and the mortality rate increases rapidly after 36 hours because the water temperature is reduced only gradually without giving cold shock.

In addition, the techniques disclosed in the above Registered Patent No. 10-1863586 and Registered Patent No. 10-1994151 are both based on a hibernation minimum water temperature (approximately 3° C.~5° C.) at which the swimming activity of the fish stops, and the temperature is lowered repeatedly in stages from the initial water temperature, which has the disadvantage that it is difficult for the fish to adapt to the lower water temperature and the inherent biological rhythm of the fish is difficult to maintain.

### RELATED TECHNICAL DOCUMENTS

### Patent Documents

(1) Korean registered patent No.: KR10-1863586 (Registration Published Date: Jun. 5, 2018)
(2) Korean registered patent No.: KR10-1994151 (Registration Published Date: Aug. 20, 2019)

### SUMMARY OF THE INVENTION

### Technical Subject

The present invention aims to solve the above problems by gradually reducing the water temperature from the initial water temperature hibernation (lowest) water temperature at which the swimming activity of the fish stops, while increasing the adaptability of the fish to the decreasing water temperature and maintaining the inherent biorhythm of the fish as much as possible, so as to extend the artificial hibernation time as long as possible.

Furthermore, the present invention aims to provide a method for inducing hibernation in fish that can reduce the overall hibernation induction time without a significant difference in mortality rate and hibernation duration by controlling the time to lower the water temperature from the hibernation-ready water temperature at which the fish no longer consume food or feed.

### Technical Solution

In one general aspect of the present invention, there may be provided a method for inducing artificial hibernation of fish according to the invention to achieve the above object, the method comprising:
an acclimatization step of acclimatizing the fish, wherein the temperature of the water containing the fish is maintained at an initial water temperature in the range of 10° C. to 30° C.;
an adaptation preparation step of lowering the temperature of the water maintained at the initial water temperature to an adaptation water temperature 1° C. to 3° C. lower than the initial water temperature for 5 to 7 hours;
an adaptation step of maintaining the adaptation water temperature for 3 to 5 hours;
a stabilization preparation step of lowering the temperature of the water maintained at the adaptation water temperature to a stabilization water temperature 1° C. to 3° C. lower than the adaptation water temperature for 5 to 7 hours; a stabilization step of maintaining the stabilization water temperature for 12 to 16 hours;
a hibernation preparation step of lowering the temperature of the water maintained at the stabilization water temperature to a hibernation preparation water temperature 0.5° C. to 2° C. lower than the stabilized water temperature for 2 to 4 hours; and
a hibernation induction step of lowering the water lowered to the hibernation preparation temperature to a hibernation water temperature 4° C. to 6° C. lower than the hibernation preparation water temperature for 4 to 6 hours.

Preferably but not necessarily, the time of lowering to the adaptation water temperature for 5 to 7 hours and the time of lowering to the stabilization water temperature for 5 to 7 hours may be the same.

Preferably but not necessarily, the temperature difference between the initial water temperature and the adaptation water temperature may be the same as the temperature difference between the adaptation water temperature and the stabilization water temperature.

Preferably but not necessarily, the time for maintaining the stabilization water temperature may be at least twice as long as the time for maintaining the adaptation water temperature.

Preferably but not necessarily, it is also possible that the hibernation preparation water temperature may be a temperature at which the fish begin to stop eating food or feed.

Preferably but not necessarily, it is also possible that the temperature difference between the hibernation preparation water temperature and the stabilization water temperature may be less than the temperature difference between the adaptation water temperature and the stabilization water temperature.

Preferably but not necessarily, the 2 to 4 hour drop to the hibernation preparation water temperature may be shorter than the 5 to 7 hour drop to the stabilization water temperature.

In another general aspect of the present invention, there may be provided a method for inducing artificial hibernation of fish, comprising:
an acclimatization step of acclimatizing the fish, while maintaining the water containing the fish within an initial water temperature in the range of 10° C. to 20° C.;
an adaptation preparation step of lowering temperature of the water maintained at the initial water temperature to an adaptation water temperature 1.5° C. lower than the initial water temperature for 6 hours;
an adaptation step of maintaining the adaptation water temperature for 4 hours;
a stabilization preparation step of lowering the temperature of the water maintained at the adaptation water temperature to a stabilization water temperature 1.5° C. below the adaptation temperature for 6 hours;
a stabilization step of maintaining the stabilization temperature for 14 hours;
a hibernation preparation step of lowering the temperature of the water maintained at the stabilization temperature to a hibernation preparation water temperature 1° C. below the stabilization water temperature for 3 hours; and
a hibernation induction step of lowering the temperature of the water lowered to the hibernation preparation water temperature to a hibernation water temperature 5° C. below the hibernation preparation water temperature for 5 hours.

In still another general aspect of the present invention, there may be provided a method of transporting artificially hibernated fish, comprising a packaging step of packaging the fish artificially hibernated by the artificial hibernation induction method.

Preferably but not necessarily, the packaging step may include removing the fish from the water and placing them in a packaging box after the fish have undergone the hibernation induction step of the artificial hibernation induction method.

Further details of other embodiments are contained in the detailed description and drawings.

### Advantageous Effects

The present invention has an advantageous effect of increasing the adaptability of the fish to the decreasing water temperature and maintaining the inherent biological rhythm of the fish as much as possible, thereby extending the time of artificial hibernation as long as possible, by further including an adaptation step and a stabilization step, where the temperature is maintained at a predetermined temperature in the process of reducing the temperature, while water temperature from the initial water temperature is gradually reduced to the hibernation (lowest) water temperature at which the fish ceases to swim, unlike the convention method of continuous and repeated reduction in temperature from the initial water temperature.

Furthermore, the present invention has another advantageous effect of reducing the artificial hibernation induction time by reducing the water temperature relatively slowly (approximately 0.33° C./hour) through the hibernation preparation stage (S310) until the hibernation preparation water temperature (approximately 8.0° C.~9.0° C.) at which the fish no longer consumes food or feed, and then reducing the water temperature relatively rapidly (approximately 1.0° C./hour) through the hibernation induction stage (S320), so that there is no significant difference between the mortality rate and the artificial hibernation maintenance time.

### BRIEF DESCRIPTION OF DRAWINGS

FIG. 1 is a flow chart to illustrate each step of a method for inducing artificial hibernation of fish according to one exemplary embodiment of the present invention,

FIG. 2 is a photograph illustrating an example of an aquarium containing halibut in accordance with one embodiment of the present invention,

FIG. 3 is a photograph illustrating an example of an aquarium containing turbot, in accordance with one embodiment of the present invention,

FIG. 4 is a photograph illustrating an example of a controller for regulating the temperature of the seawater in the aquarium, in accordance with one embodiment of the present invention,

FIG. 5 is a photograph illustrating an example of weighing halibut in accordance with the present invention,

FIG. 6 is a photograph illustrating an example of placing halibut induced into artificial hibernation in accordance with the present invention into a packaging box,

FIG. 7 is a photograph showing an example of a bulk box containing halibut induced into artificial hibernation according to the present invention.

### DETAILED DESCRIPTION

The present invention is subject to various modifications and can have many different embodiments, certain embodiments of which are illustrated in the drawings and described in detail in the accompanying description. However, this is not intended to limit the invention to any particular embodiment, and is to be understood to include all modifications, equivalents or substitutions that fall within the scope of the present idea and technology. In describing the invention, detailed description of the relevant prior art is omitted where it is believed that such description would obscure the gist of the invention.

The terminology used in this application is for the purpose of describing particular embodiments only and is not intended to limit the invention. Expressions in the singular include the plural unless the context clearly indicates otherwise. In this application, the terms “comprising” or “having” and the like are intended to designate the presence of the features, numbers, steps, operations, components, parts, or combinations thereof described in the specification and are not intended to preclude the possibility of the presence or addition of one or more other features, numbers, steps, operations, components, parts, or combinations thereof.

Terms such as first, second, and the like may be used to describe various components, but the components are not to be limited by such terms. The terms are used only for the purpose of distinguishing one component from another.

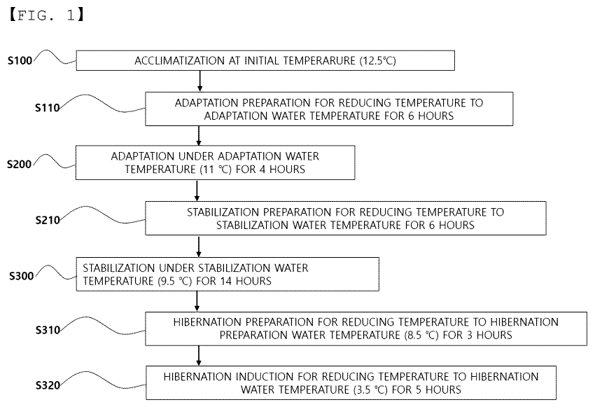

FIG. 1 is a flow chart to illustrate each step of a method for inducing artificial hibernation of fish according to one embodiment of the present invention.

The method for inducing artificial hibernation of fish according to the present invention is directed to a method for inducing artificial hibernation of fish, comprising:
acclimatization step (S100);
adaptation preparation step (S110);
adaptation step (S200);
stabilization preparation step (S210);
stabilization step (S300);
hibernation preparation step (S310); and
hibernation induction step (S320).

Each of these steps will be described in more detail below.

### [Acclimatization Step (S100)]

The acclimatization step (S100) according to the present invention is to acclimatize the fish while maintaining the temperature of the water containing the fish at an initial water temperature in the range of 10° C. to 30° C.

As a process of stabilizing the fish at the initial water temperature for a certain period of time, the fish may be acclimatized in water of normal water temperature or in seawater.

The initial water temperature refers to the water temperature that fish normally live in, such as the water temperature in a fish farm. In one example, it may be set at 20° C., but is not limited to this. For example, the initial water temperature may be between 10° C. and 30° C.

Preferably, but not exclusively, the fish are stabilized at the initial water temperature for at least 12 hours. For example, the fish may be stabilized at the initial water temperature for about 6 hours to 12 hours.

The initial water temperature and the time required for stabilization may be set depending on a variety of factors, including the species of fish, the habitat of the fish, the season, etc. For example, for tropical fish, the water temperature required for initial stabilization is 24-26° C. For halibut, it varies depending on the season, but is between 17-19° C. in summer and 9-13° C. in winter.

To give a concrete example of the acclimatization process, when fish are transported by live car (live fish carrier) from the source of production (fish farm) to the factory where they are induced to hibernate, they can be affected by the noise of the car's engine and the stress of travelling on the road, so by allowing them to stabilize in the initial water temperature for a sufficient period of time, the stress during transport can be reduced.

[Adaptation preparation step (S110)]

The acclimatization preparation step (S110) according to the present invention comprises reducing the temperature of the water maintained at the initial water temperature to an acclimatization temperature of 1° C. to 3° C. lower than the initial water temperature for 5 to 7 hours.

The acclimatization preparation step (S110) is the first step in inducing artificial hibernation in the fish by gradually decreasing the water temperature from the initial water temperature to the acclimatization temperature.

In the acclimatization preparation stage (S110), the water temperature is preferably reduced to an acclimatization temperature that is 1° C. to 3° C. (preferably 1° C. to 2° C.) lower than the initial water temperature to allow the fish to acclimatize to the lower water temperature. To do this, it is recommended that the water temperature is lowered gradually and slowly over a period of 5-7 hours, rather than abruptly. This will allow the fish to gradually adapt to the lower water temperature and induce a natural artificial hibernation.

The rate at which the water temperature is lowered can be varied. For example, the process of reducing the water temperature may be carried out at a rate of 0.2° C./hour to 0.5° C./hour, preferably at a rate of 0.25° C./hour, but not exclusively.

As a specific example, in the case of winter, assuming that the initial water temperature is 12.5° C. in the stabilization stage (S100), stabilization is performed at the initial water temperature for more than 6 hours, and in the adaptation preparation stage (S110), the water temperature is slowly lowered to an adaptation water temperature of 11° C. for 6 hours at a rate of ‘0.25° C./hour’.

[Adaptation step (S200)]

The acclimatization step (S200) according to the present invention comprises maintaining the acclimatization water temperature for 3 to 5 hours.

In other words, the water temperature is reduced to the acclimatization temperature through the acclimatization preparation step (S110) and then maintained at the acclimatization temperature for a substantial period of time to give the fish time to adapt to the reduced water temperature.

This acclimatization step (S200) may be carried out for 1-8 hours, 2-6 hours, 3-5 hours, and preferably for 4 hours.

The conventional method of inducing artificial hibernation is to lower the temperature of the water step by step and repeatedly from the initial water temperature without maintaining the water temperature at a constant temperature, which has the disadvantage that it is difficult for the fish to adapt to the lowered water temperature and the inherent biorhythm of the fish is difficult to be maintained.

The present inventors have developed a method for gradually reducing the water temperature from the initial water temperature to the hibernation (lowest) water temperature at which the swimming activity of the fish stops, but instead of continuously and repeatedly reducing the temperature from the initial water temperature as in the further includes an conventional method, method the adaptation step (S200) that maintains the water temperature at a constant temperature during the process of gradually reducing the water temperature, The present invention was completed after it was found that the adaptability of the fish to the decreasing water temperature can be increased, and the inherent biorhythm of the fish can be maintained as much as possible, thereby extending the time of artificial hibernation as long as possible.

As a specific example, when the water temperature is slowly lowered to an acclimatization temperature of 11° C. for 6 hours through the acclimatization preparation step (S110), it is possible that the acclimatization step (S200) maintains the acclimatization temperature for 3 to 5 hours (preferably 4 hours) to allow the fish to acclimatize.

### [Stabilization Preparation Step (S210)]

The stabilization preparation step (S210) according to the present invention is to lower the temperature of the water maintained at the adaptation water temperature to a stabilization water temperature of 1° C. to 3° C. lower than the adaptation water temperature for 5 to 7 hours.

In other words, the water temperature is kept constant through the above adaptation step (S200), and then the water temperature is further lowered again.

The stabilization preparation step (S210) is a stage in which the water temperature is gradually reduced from the adaptation water temperature to the stabilization water temperature to induce deeper artificial hibernation in the fish.

In the stabilization preparation stage (S210), it is preferable to reduce the water temperature to a stabilization water temperature that is 1° C. to 3° C. (preferably 1° C. to 2° C.) lower than the adaptation water temperature so that the fish can adapt to the lower water temperature. To do this, it is recommended that the water temperature is lowered gradually and slowly over a period of 5 to 7 hours, rather than abruptly. This will allow the fish to gradually adapt to the lower water temperature and induce a more natural and deeper artificial hibernation.

The rate at which the water temperature is lowered can be varied. For example, the process of lowering the water temperature may be carried out at a rate of 0.2° C./hour to 0.5° C./hour, preferably at a rate of 0.25° C./hour, and is not limited thereto.

As a specific example, if the adaptation water temperature is 11.0° C. in the adaptation step (S200) above, the water temperature can be slowly reduced to the stabilization water temperature of 9.5° C. for 6 hours in the stabilization preparation step S210 at a rate of ‘0.25° C./hour’.

Here, the invention may be that the time from the adaptation preparation step (S110) to the adaptation water temperature for 5 to 7 hours and the time from the stabilization preparation step (S210) to the stabilization water temperature for 5 to 7 hours are the same. For example, if the above adaptation preparation step (S110) is performed for 6 hours, the above stabilization preparation step (S210) is also performed for 6 hours. By equating the time of lowering the water temperature before and after acclimatization step (S200), it is possible to provide the fish with the same proportion of time to change the water temperature in the same proportion, thereby minimizing the stress on the fish.

Furthermore, the present invention enables the temperature difference (e.g., 1.5° C.) between the initial water temperature (e.g., 12.5° C.) and the adaptation water temperature (e.g., 11.0° C.) to be the same as the temperature difference (e.g., 1.5° C.) between the adaptation water temperature (e.g., 11.0° C.) and the stabilization water temperature (e.g., 9.5° C.). By making the temperature change of lowering the water temperature the same before and after the adaptation step S200, it may be possible to provide the same proportion of the temperature change of the water temperature to which the fish belongs in the same proportion, and thereby minimize stress to the fish.

[Stabilization step (S300)]

The stabilization step (S300) according to the present invention is to maintain the stabilizing water temperature for 12 to 16 hours.

In other words, the water temperature is lowered to the stabilization water temperature through the stabilization preparation step (S210) and then maintained at the stabilizing water temperature for a considerable period of time to give the fish time to adapt to the lowered water temperature.

This stabilization step (S300) may comprise maintaining the stabilizing water temperature for 10 to 18 hours, 12 to 16 hours, 13 to 15 hours, and preferably 14 hours.

As a specific example, if the water temperature has been slowly lowered to the stabilization water temperature of 9.5° C. for 6 hours through the stabilization preparation step (S210), the stabilization step (S300) may maintain the stabilization water temperature for 12 to 16 hours, preferably 14 hours, to allow the fish to acclimatize.

The present invention provides for a gradual decrease in water temperature from the initial water temperature to the hibernation (lowest) water temperature at which the swimming activity of the fish ceases, rather than a continuous and repeated decrease in temperature from the initial water temperature as is conventionally done, wherein the step of maintaining the water temperature at a constant temperature during the process of gradually reducing the water temperature is characteristically further divided into two stages, an adaptation stage (S200) and a stabilization stage (S300), so that the adaptability of the fish to the decreasing water temperature can be increased and the inherent biorhythm of the fish can be maintained as much as possible.

Furthermore, in the present invention, the time for maintaining the stabilization water temperature may be at least twice as long, or at least three times as long as the time for maintaining the acclimatization water temperature. By maintaining the fish at a stabilization water temperature that is lower than the acclimatization water temperature for a longer period of time, the adaptive capacity of the fish can be further effectively enhanced.

[Hibernation preparation step (S310)]

The hibernation preparation step (S310) according to the present invention is to lower the temperature of the water maintained at the above stabilization water temperature to a hibernation preparation water temperature that is 0.5° C. to 2° C. lower than the above stabilization water temperature for 2 to 4 hours.

As a specific example, when the stabilization water temperature (9.5° C.) has been maintained for 12 to 16 hours (preferably 14 hours) through the above stabilization step (S300), the hibernation preparation step (S310) may slowly lower the water temperature to the hibernation preparation water temperature of 8.5° C. for 3 hours at a rate of “0.33° C./hour”.

Only by slowly lowering the temperature to the hibernation preparation water temperature, which is 0.5° C.~2° C. lower than the stabilization water temperature, for a relatively long time of 2~4 hours, the biorhythm of the fish was maintained and the fish adapted well to the lowered temperature, while lowering the temperature in a shorter period of time resulted in a shorter adaptation time for the fish and a higher mortality rate.

In the present invention, “hibernation preparation water temperature” refers to the temperature of water at which fish no longer consume food or feed, i.e., the hibernation ready water temperature may be the temperature at which the fish begin to stop eating food or feed. At the above hibernation preparation water temperature, the fish are no longer consuming food or feed, but are still able to swim or swim in the water. This hibernation temperature can vary depending on the species and season of the year, and may be slightly lower in the winter than in the summer, but has been found to be generally in the range of 8.0° C. to 9.0° C. in the winter.

The inventor learnt that fish stop consuming food or feed at a certain temperature when the water temperature decreases, and assumed that the intrinsic biological rhythm of fish may change significantly at this temperature, and conducted various experiments. For example, the time of lowering the water temperature before and after the hibernation preparation water temperature was varied, but there was no significant difference in the mortality rate and the duration of artificial hibernation. Furthermore, it was thought that maintaining the water temperature at a constant temperature such as the above-mentioned adaptation step (S200) and stabilization step (S300) at the hibernation preparation water temperature would be more advantageous for the adaptation of the fish, but it was confirmed that including a step of maintaining a constant water temperature at the hibernation preparation water temperature was not very helpful, as can be seen in the following experimental examples.

Therefore, the present inventor completed the present invention after realizing that when the water temperature reaches the hibernation preparation water temperature, the fish are in a state in which the fish are moving and swimming but not eating food or feed, i.e., the activity of the fish remains the same to the naked eye, but the fish are intrinsically significantly atrophied by the low temperature and artificial hibernation has begun to progress to a large extent, and at this stage it is unnecessary to maintain the water temperature at a constant temperature as in the adaptation stage (S200) and stabilization stage (S300) described above.

Accordingly, the present invention is characterized in that the temperature of the water is lowered to a hibernation preparation water temperature of 0.5° C. to 2° C. lower than the stabilization water temperature for 2 to 4 hours through the hibernation preparation step (S310), and then the water is not maintained hibernation preparation water temperature for a certain period of time, and is immediately followed by the hibernation induction step (S320) described later.

### [Hibernation Induction Stage (S320)]

The hibernation induction step (S320) according to the present invention comprises lowering the temperature of the water to a hibernation water temperature 4° C. to 6° C. lower than the hibernation water temperature for 4 to 6 hours.

As used herein, the term “hibernation water temperature” refers to the starting point of the temperature at which fish become immobile and give up swimming activity. Thus, when the water temperature reaches the hibernation water temperature, hibernation is directly induced in the fish.

In other words, the present invention is characterized in that the temperature is lowered slowly over a relatively long period of time to a hibernation water temperature that is 4° C. to 6° C. lower than the above hibernation preparation water temperature. It is preferable to lower the temperature by about 1° C. per hour, and if the temperature is lowered in a shorter period of time than this, the fish begin to bleed and the mortality rate increases.

The present invention has the effect of reducing the artificial hibernation induction time by reducing the water temperature relatively slowly (approximately 0.33° C./hour) through the hibernation preparation step (S310) until the hibernation preparation step (S310), when the fish no longer consume food or feed, and relatively rapidly (approximately 1.0° C./hour) through the hibernation induction step (S320) thereafter, so that there is no significant difference in the mortality rate and the artificial hibernation maintenance time.

Furthermore, as another feature of the present invention, it is possible that the temperature difference (e.g., 1.0° C.) between the hibernation preparation water temperature (e.g., 8.5° C.) and the stabilization water temperature (e.g., 9.5° C.) is smaller than the temperature difference (e.g., 1.5° C.) between the adaptation water temperature (e.g., 11.0° C.) and the stabilization water temperature (e.g., 9.5° C.). The closer the temperature is reduced to the hibernation preparation water temperature, the smaller the temperature reduction can be, which means that it is more important to have a relatively small deviation in temperature during the acclimatization preparation stage (S110) and/or stabilization preparation step (S210).

Furthermore, as another characteristic of the present invention, the time of lowering to the hibernation preparation water temperature (e.g., 8.5° C.) for 2 to 4 hours (preferably 3 hours) may be shorter than the time of lowering to the stabilization water temperature (e.g., 9.5° C.) for 5 to 7 hours (preferably 6 hours). Since the temperature change (e.g., 1° C.) in the hibernation preparation stage S310 is smaller than the temperature change (e.g., 1.5° C.) in the stabilization preparation stage (S210), and since the fish entering the hibernation preparation water temperature (8.5° C.) after passing through the stabilization water temperature (9.5° C.) have less feed intake and activity, it is possible to maintain the adaptability of the fish even if the time for lowering the water temperature is slightly shorter.

Another example of the present invention is a method of inducing artificial hibernation of fish, comprising:
an acclimatization step of acclimatizing the fish while maintaining the temperature of the water containing the fish at an initial water temperature in the range of 10° C. to 20° C.;
an adaptation preparation step of lowering the temperature of the water maintained at the initial water temperature to an acclimatization water temperature 1.5° C. lower than the initial water temperature for 6 hours;
an adaptation step of maintaining the acclimatization water temperature for 4 hours; and
a stabilization preparation step of lowering the temperature of the water maintained at the adaptation water temperature to a stabilization water temperature 1.5° C. below the adaptation water temperature for 6 hours;
a stabilization step of maintaining the stabilization water temperature for 14 hours;
a hibernation preparation step of lowering the temperature of the water maintained at the stabilization water temperature to a hibernation preparation water temperature 1° C. below the stabilization water temperature for 3 hours; and a hibernation induction step of lowering the temperature of the water lowered to the hibernation preparation water temperature to a hibernation water temperature 5° C. below the hibernation preparation water temperature for 5 hours.

The present invention is characterized in that it further comprises an adaptation step and a stabilization step in which the water temperature is maintained at a constant temperature during the process of gradually decreasing the water temperature, thereby increasing the adaptability of the fish to the decreasing water temperature and maintaining the fish's inherent biorhythm as much as possible, thereby accomplishing the effect of extending the time of artificial hibernation as long as possible.

Another embodiment of the invention is a method of transporting fish in artificial hibernation, comprising: a packaging step of packaging the fish artificially hibernated by the method of inducing hibernation described above; i.e., a transport method for transporting fish artificially hibernated by the method described above.

The method of packaging the fish is not particularly limited and may include various methods known in the art.

In one example, the packaging step may comprise removing the fish from the water after the hibernation induction step of the artificial hibernation induction method and placing the fish in a packaging box.

The packaging box is also not particularly limited and may include various methods known in the art.

For example, it is possible to use the packaging method and packaging box disclosed in Registered Patent No. 10-1863586 and Registered Patent No. 10-1994151 filed by the applicant.

The transport method of the present invention has the effect that fish can be packaged and transported in a state of artificially induced hibernation for at least 36 hours in an anhydrous environment.

The present invention can be better understood by the following embodiments, which are for illustrative purposes only and are not intended to limit the scope of protection afforded by the appended patent claims.

### Embodiments 1 to 5: Artificial Hibernation Induction Including Adaptation and Stabilization Steps

An artificial hibernation induction experiment was performed on halibut.

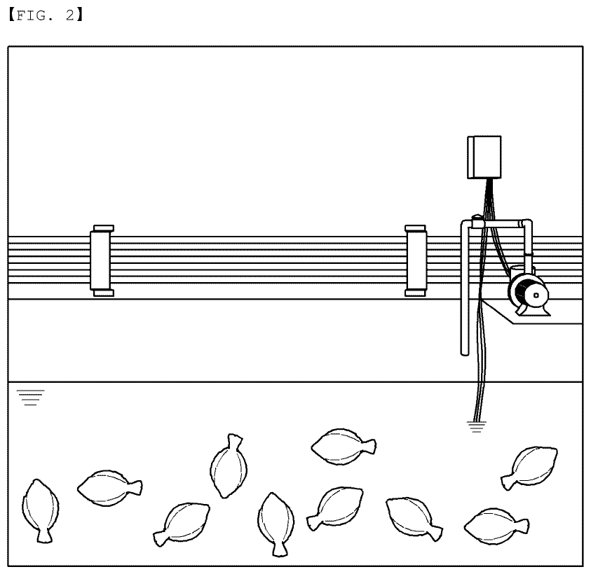

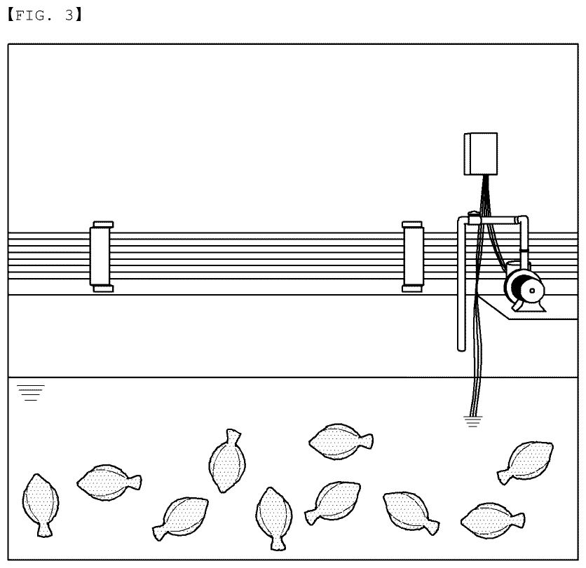

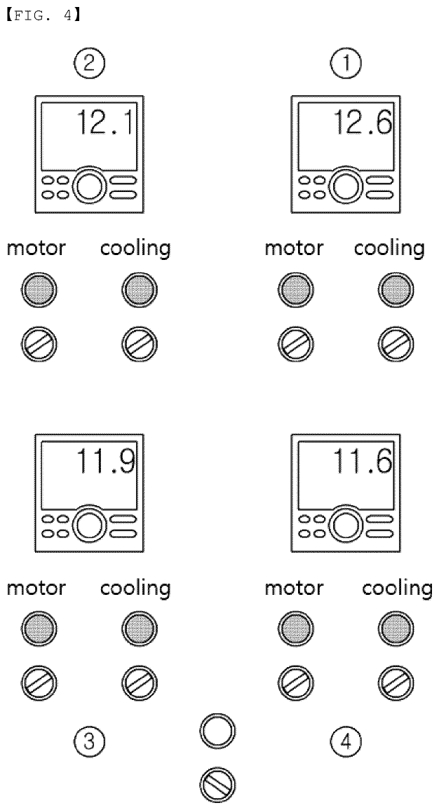

FIG. 2 is a photograph illustrating an example of an aquarium containing halibut according to one embodiment of the present invention, FIG. 3 is a photograph illustrating an example of an aquarium containing a turbot according to one embodiment of the present invention, and FIG. 4 is a photograph illustrating an example of a controller for adjusting the temperature of seawater in the aquarium according to one embodiment of the present invention.

The aquarium was pre-filled with seawater at 12.5° C. during the winter months, 140 halibut (or turbot) per experiment (see FIGS. 2 and 3), and then the time and temperature were adjusted to vary the temperature of the seawater in the aquarium as shown in Table 1 below. The water temperature was regulated by supplying lower temperature seawater through a chiller connected to the tank, and the temperature and time were controlled using a controller connected to the chiller (see FIG. 4).

For example, in Example 1, the halibut were acclimatized in 12.5° C. seawater for 12 hours, the water temperature was reduced to 11.0° C. for 6 hours, and once the water temperature reached 11.0° C., it was maintained for 4 hours to allow the halibut to acclimatize. The water temperature was then lowered to 9.5° C. for 6 hours, and once the water temperature reached 9.5° C., it was maintained for 14 hours to allow the halibut to stabilize. Then, the water temperature was again adjusted to decrease to 8.5° C. for 3 hours, and when the water temperature reached 8.5° C., it was maintained for 6 hours, and then adjusted to decrease rapidly to 3.5° C. for 5 hours.

The temperature and time adjustments according to Examples 2-5 are shown in Table 1 below.

TABLE 1

| Water | exemplary | exemplary | exemplary | exemplary | exemplary |
|---|---|---|---|---|---|
| temperature | embodi- | embodi- | embodi- | embodi- | embodi- |
| (° C.) | ment 1 | ment 2 | ment 3 | ment 4 | ment 5 |
| 12.5 | 12 hour | 12 hour | 12 hour | 12 hour | 12 hour |
| 12.5~11.0 | 6 hour | 6 hour | 6 hour | 6 hour | 6 hour |
| 11.0 | 4 hour | 4 hour | 4 hour | 4 hour | 1 hour |
| 11.0~9.5 | 6 hour | 6 hour | 6 hour | 6 hour | 6 hour |
| 9.5 | 14 hour | 14 hour | 14 hour | 8 hour | 2 hour |
| 9.5~8.5 | 3 hour | 3 hour | 3 hour | 1 hour | 1 hour |
| 8.5 | 6 hour | 3 hour | — | — | — |
| 8.5~3.5 | 5 hour | 5 hour | 5 hour | 5 hour | 5 hour |
| 3.5 | — | — | — | — | — |

### Comparative Example 1: Artificial Hibernation Induction Including Cold Shock

In Comparative Example 1, artificial hibernation was induced by a known method including cold shock (see Korean Registered Patent KR10-1863586).

In other words, the overall method was as described in the above embodiment, but the water temperature of the seawater was adjusted as shown in Table 2 below.

TABLE 2

| Water temperature (° C.) | hour |
|---|---|
| 15 | 12 |
| 15~10 | 6 |
| 10~5 | 6 |
| 5 | 24 |
| 5~3 | 0.05 (3 minutes) |

### Comparative Example 2: Artificial Hibernation Induction Including a Continuous Temperature Drop

In Comparative Example 2, artificial hibernation was induced by a previously known method involving a continuous temperature drop (see Korean Registered Patent KR10-1994151).

In other words, the overall method was as described in the above embodiment, but the water temperature of the seawater was adjusted as shown in Table 3 below.

TABLE 3

| Water temperature (° C.) | hour |
|---|---|
| 16 | 6 |
| 16~12 | 8 |
| 12~8 | 8 |
| 8~4 | 12 |
| 4 | 12 |

### Experimental Example: Survival Rate and Anhydrous Hibernation Induction Time

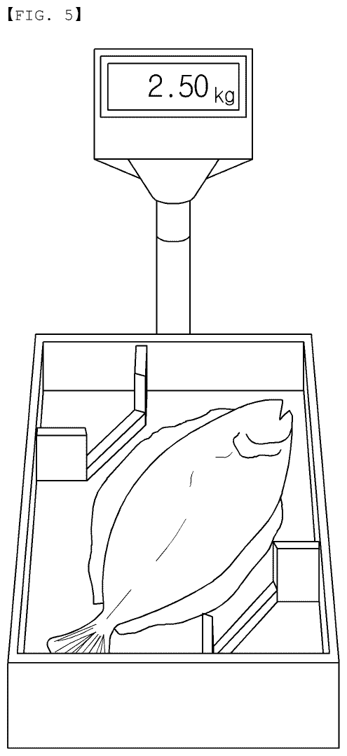

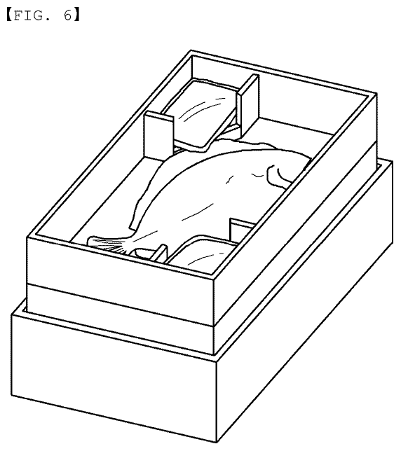

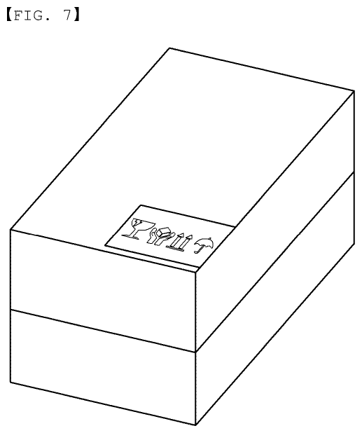

FIG. 5 is a photograph illustrating an example of weighing halibut according to the invention, FIG. 6 is a photograph illustrating an example of placing artificially hibernated halibut according to the invention in a packaging box, and FIG. 7 is a photograph illustrating an example of a bulk box containing artificially hibernated halibut according to the invention.

The artificially hibernated halibut were taken out of the water tank in the same manner as in Examples 1 to 5 and Comparative Examples 1 and 2 above, transferred to a temperature chamber, weighed individually (see FIG. 5), and the temperature of the temperature chamber was set to 4° C. (±1° C.) during packaging, and the initial temperature in the packaging box was also maintained at 4 to 5° C. The refrigerant was then loaded together and kept at around 6° C. for more than 36 hours (see FIG. 6). Then, the packaging boxes were stacked and placed in a bulk box and sealed to prevent air movement in the atmosphere (see FIG. 7). Then, two holes with a diameter of 1 cm were drilled diagonally in the bulk box, oxygen was injected with an air gun at 2 atmospheres for more than 1 minute to keep the oxygen concentration above 40.0%, which is about twice the atmospheric concentration, the holes were plugged with plugs, and the gaps around the holes were sealed with silicone.

Then, after 30 and 36 hours, the bulk box was opened, and the halibut in the packaging box was placed in seawater at 8° C., and the survival rate was checked after 24 hours. The results of the experiment are shown in Table 4 below.

TABLE 4

| | | | | Survival | Survival |
|---|---|---|---|---|---|
| | | Average | | rate | rate |
| | | body | Average | after 30 hour | after 36 |
| | population | length | weight | lapse (%) | lapse (%) |
| exemplary | 20 | 550 | 2,160 | 95 | 90 |
| embodiment | | | | | |
| 1 | | | | | |
| exemplary | 20 | 580 | 2,340 | 90 | 90 |
| embodiment | | | | | |
| 2 | | | | | |
| exemplary | 20 | 560 | 2,420 | 90 | 90 |
| embodiment | | | | | |
| 3 | | | | | |
| exemplary | 20 | 570 | 2,660 | 80 | 75 |
| embodiment | | | | | |
| 4 | | | | | |
| exemplary | 20 | 572 | 2,650 | 75 | 70 |
| embodiment | | | | | |
| 5 | | | | | |
| comparative | 20 | 568 | 2,630 | 75 | 70 |
| example 1 | | | | | |
| comparative | 20 | 575 | 2,680 | 75 | 65 |
| example 2 | | | | | |

As shown in Table 4 above, exemplary embodiments 1 to 3 of the present invention showed uniformly good survival rates at 30 hours and 36 hours. The results of Embodiments 1-3 were not significantly different, and among them, Embodiment 1 was slightly better, and Embodiment 3 had the advantage of slightly reducing the overall artificial hibernation induction time.

In comparison, the survival rate was somewhat lower for embodiments 4 and 5, which can be explained by the shorter time for the stabilization and/or hibernation preparation phase and the shorter time for the adaptation phase.

Furthermore, according to the conventional method as in Examples 1 and 2, the overall survival rate is low after 30 hours, and it is significantly lower after 36 hours.

Although the invention has been shown and described above with reference to certain preferred embodiments, it will be apparent to those skilled in the art that various modifications and changes can be made to the invention without departing from the technical features and field of the invention as established by the following patent claims.

1. A method for inducing artificial hibernation of fish, the method comprising:
an acclimatization step of acclimatizing the fish, wherein the temperature of the water containing the fish is maintained at an initial water temperature in the range of 10° C. to 30° C.;
an adaptation preparation step of lowering the temperature of the water maintained at the initial water temperature to an adaptation water temperature 1° C. to 3° C. lower than the initial water temperature for 5 to 7 hours;
an adaptation step of maintaining the adaptation water temperature for 3 to 5 hours;
a stabilization preparation step of lowering the temperature of the water maintained at the adaptation water temperature to a stabilization water temperature 1° C. to 3° C. lower than the adaptation water temperature for 5 to 7 hours;
a stabilization step of maintaining the stabilization water temperature for 12 to 16 hours;
a hibernation preparation step of lowering the temperature of the water maintained at the stabilization water temperature to a hibernation preparation water temperature 0.5° C. to 2° C. lower than the stabilized water temperature for 2 to 4 hours; and
a hibernation induction step of lowering the water lowered to the hibernation preparation temperature to a hibernation water temperature 4° C. to 6° C. lower than the hibernation preparation water temperature for 4 to 6 hours.

2. The method of claim 1, wherein the time of lowering to the adaptation water temperature for 5 to 7 hours and the time of lowering to the stabilization water temperature for 5 to 7 hours are the same.

3. The method of claim 1, wherein the temperature difference between the initial water temperature and the adaptation water temperature is the same as the temperature difference between the adaptation water temperature and the stabilization water temperature.

4. The method of claim 1, wherein the time for maintaining the stabilization water temperature is at least twice as long as the time for maintaining the adaptation water temperature.

5. The method of claim 1, wherein the hibernation preparation water temperature is a temperature at which the fish begin to stop eating food or feed.

6. The method of claim 1, wherein the temperature difference between the hibernation preparation water temperature and the stabilization water temperature is less than the temperature difference between the adaptation water temperature and the stabilization water temperature.

7. The method of claim 1, wherein the 2 to 4 hour drop to the hibernation preparation water temperature is shorter than the 5 to 7 hour drop to the stabilization water temperature.

8. A method for inducing artificial hibernation of fish, comprising:
an acclimatization step of acclimatizing the fish, while maintaining the water containing the fish within an initial water temperature in the range of 10° C. to 20° C.;
an adaptation preparation step lowering the temperature of the water maintained at the initial water temperature to an adaptation water temperature 1.5° C. lower than the initial water temperature for 6 hours;
an adaptation step of maintaining the adaptation water temperature for 4 hours;
a stabilization preparation step of lowering the temperature of the water maintained at the adaptation water temperature to a stabilization water temperature 1.5° C. below the adaptation temperature for 6 hours;
a stabilization step of maintaining the stabilization temperature for 14 hours;
a hibernation preparation step of lowering the temperature of the water maintained at the stabilization temperature to a hibernation preparation water temperature 1° C. below the stabilization water temperature for 3 hours; and
a hibernation induction step of lowering the temperature of the water lowered to the hibernation preparation water temperature to a hibernation water temperature 5° C. below the hibernation preparation water temperature for 5 hours.

9. A method of transporting artificially hibernated fish, comprising a packaging step of packaging the fish artificially hibernated by the artificial hibernation induction method of claim 1.

10. The method of claim 9, wherein the packaging step includes removing the fish from the water and placing them in a packaging box after the fish have undergone the hibernation induction step of the artificial hibernation induction method.
